(19) United States
(12) Patent Application Publication
(10) Pub. No.: US 2012/0254958 A1
(43) Pub. Date: Oct. 4, 2012

(54) METHOD TO ACHIEVE COEXISTENCE OF MULTIPLE WIRELESS NETWORKS USING UNIQUE NETWORK IDENTIFIERS

(75) Inventors: Ramakrishna Budampati, Maple Grove, MN (US); Joseph Citrano, III, Eden Prairie, MN (US)

(73) Assignee: HONEYWELL INTERNATIONAL INC., Morristown, NJ (US)

(21) Appl. No.: 13/075,529

(22) Filed: Mar. 30, 2011

(51) Int. Cl. G06F 15/177; G06F 21/00

(52) U.S. Cl. 726/6; 709/220

(57) ABSTRACT

The techniques of this disclosure generate a random network identifier to a network device to set up a wireless network. The generated random network identifier may be compared to network identifiers of other wireless networks within the range of the network device. If the generated network identifier matches any of the network identifiers within the range, a new random network identifier may be generated, until a generated network identifier does not match any of the network identifiers within the range. The network device may then assign the generated unique network identifier as the wireless network's network identifier and send the network identifier to all the devices that wish to join the wireless network.

### TECHNICAL FIELD

This disclosure relates to networks, and more particularly to wireless networks.

### BACKGROUND

Wireless networks are used in a variety of applications, and the specific protocol used to set up a wireless network may depend on the purpose of the network, the range the network needs to cover, and the power consumption requirements. ZigBee is a wireless network specification based on the IEEE 802.15.4 standard. ZigBee networks are used in low-power applications such as wireless light switches, in-home displays, consumer electronics, and the like. ZigBee networks are generally low-rate wireless personal area networks (PANs) that are simpler and less expensive to operate than other types of PANs. ZigBee networks are usually targeted at radio frequency applications that require a low data rate, long battery life, and secure networking.

### SUMMARY

In general, the disclosure describes techniques for assigning unique network identifier to a wireless networks within close proximity to other wireless networks. Some wireless networks, such as those based on the ZigBee standard or IEEE 802.15.4 standard, use personal area network identifiers (PAN IDs) to identify a given network relative to other similar networks that may overlap with the given network. Devices that connect to the network may use the PAN ID to identify the network with which they are associated. A PAN ID may identify a wireless network to allow communication between a coordinator device of the network and end devices.

The techniques of this disclosure generate a random PAN ID for a network device to set up a wireless network. The generated random PAN ID may be then compared to PAN IDs of other wireless networks within the range of the network device. If the generated PAN ID matches any of the PAN IDs associated with devices within the range, a new random PAN ID may be generated, until the generated PAN ID does not match any of the PAN IDs associated with devices within the range. In this manner, a unique PAN ID is generated for the network device, which may then assign the generated PAN ID as the wireless network's PAN ID and send the PAN ID to all the devices that wish to join the wireless network. The PAN ID is then utilized in communications among the devices of the wireless network.

In one example, the disclosure is directed to a method comprising generating, by a random number generator in a network device, a random network identifier, detecting identifiers associated with other network devices, wherein the other network devices are located within a scanning range associated with the network device, comparing the identifiers associated with the other network devices with the generated random network identifier, and assigning the generated random network identifier as an identifier of the network device when the generated random network identifier is unique relative to the identifiers associated with the other network devices.

In another example, the disclosure is directed to a network device comprising a random number generator configured to generate a random network identifier, a scanning module configured to detect identifiers associated with other network devices, wherein the other network devices are located within a scanning range associated with the network device, a comparator configured to compare the identifiers associated with the other network devices with the generated random network identifier, and a selection module for assigning the generated random network identifier as an identifier of the network device when the generated random network identifier is unique relative to the identifiers associated with the other network devices.

In another example, the disclosure is directed to a computer-readable storage medium comprising instructions that, when executed, cause one or more processors of a network device to generate, by a random number generator, a random network identifier, detect identifiers associated with other network devices, wherein the other network devices are located within a scanning range associated with the network device, compare the identifiers associated with the other network devices with the generated random network identifier, and assign the generated random network identifier as an identifier of the network device when the generated random network identifier is unique relative to the identifiers associated with the other network devices.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example wireless network that can implement techniques of this disclosure.

FIG. 2A is a block diagram illustrating an example set of wireless network coordinators within a neighborhood of a wireless network coordinator.

FIG. 2B is a block diagram illustrating an example of a wireless network relative to neighboring wireless networks.

FIG. 3A is a block diagram illustrating an example wireless network in accordance with techniques of this disclosure.

FIG. 3B is a block diagram illustrating an example PAN ID selector module in accordance with technique of this disclosure.

FIG. 4 is a flow chart of an example method for assigning a unique network identifier to a wireless network.

### DETAILED DESCRIPTION

In general, the disclosure describes techniques for assigning unique network identifier to a wireless networks within close proximity to other wireless networks. Some wireless networks use personal area network identifiers (PAN IDs) that allow devices to associate with the network. One example of such networks may be those based on the ZigBee standard or IEEE 802.15.4 standard. Devices that connect to the network may use the PAN ID to identify the network with which they are associated. A PAN ID may be utilized among devices of a wireless network to allow communication between a coordinator device of the network and end devices.

Some wireless networks, such as those based on the ZigBee standard, may be a low-cost and low-power wireless network option that can be used in applications that require low data rates and low power consumption. For example, ZigBee wireless networks may be used in industrial control, medical data collection, smoke and intruder warning, building/home automation, and the like. Specific examples may include home entertainment and control such as, smart lighting, temperature control, security devices, entertainment systems, and so forth.

While the techniques of this disclosure are described with respect to ZigBee networks and the IEEE 802.15.4 standard, it should be understood that these techniques are applicable to all other wireless networks and standards that use unique identifiers for the networks. One example of such wireless networks and standards may be auto-forming Wi-Fi wireless networks.

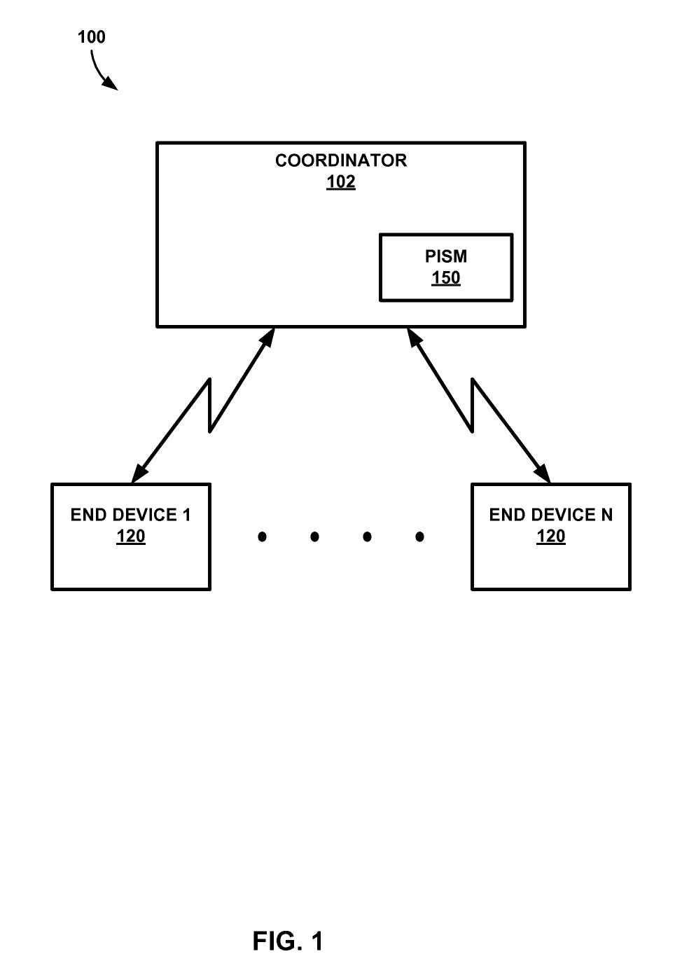

FIG. 1 is a block diagram illustrating an example wireless network 100 that can implement the techniques of this disclosure. Network 100 may be, for example, a ZigBee network, based on the IEEE 802.15.4 standard. Network 100 may include coordinator 102 and one or more end devices 120. Typically, in a ZigBee network 100, there is one coordinator device, which forms the root of the network and is the device that is used to set up the network, and communicate with and control operations associated with end devices 120. Among other functionalities, coordinator 102 may be responsible for selecting the network's PAN ID at the time of establishing the network. Coordinator 102 may communicate with end devices 120 to control their operations (e.g., turn on/off the light, change a temperature setting, capture an image, or the like). In some examples, network 100 may also include a ZigBee router (not shown), which may act as an intermediate router between coordinator 102 and end devices 120.

In some examples, wireless networks, such as wireless network 100 of FIG. 1, may be set up in buildings or homes to control operations of devices for applications that require low data rate and power consumption. As a result, when several homes or businesses set up wireless networks in a dense area (e.g., an apartment building, a skyscraper, or the like), several networks may be operating in the same neighborhood, where the neighborhood may be defined by the scanning range of a coordinator of a network. The scanning range of a coordinator may be a distance from a coordinator, e.g., 100 feet, within which the coordinator can detect the presence of other network devices. The coordinator may detect other networks and network devices by detecting identifiers associated with the network and used in communications between devices of the network. Therefore, interference and cross-talk between coordinators and end devices associated with different wireless networks may become an issue if each of the wireless networks does not have an identifier that is unique relative to the identifiers of other wireless networks within a certain range.

In one example, coordinator 102 may include several components including PAN ID selector module 150. During set-up of a wireless network coordinator 102 may utilize PAN ID selector module 150 to generate a unique PAN ID relative to PAN IDs associated with devices and wireless networks within the scanning range of coordinator 102. PAN ID selector module 150 may generate the unique PAN ID according to techniques of this disclosure, as described below in more detail.

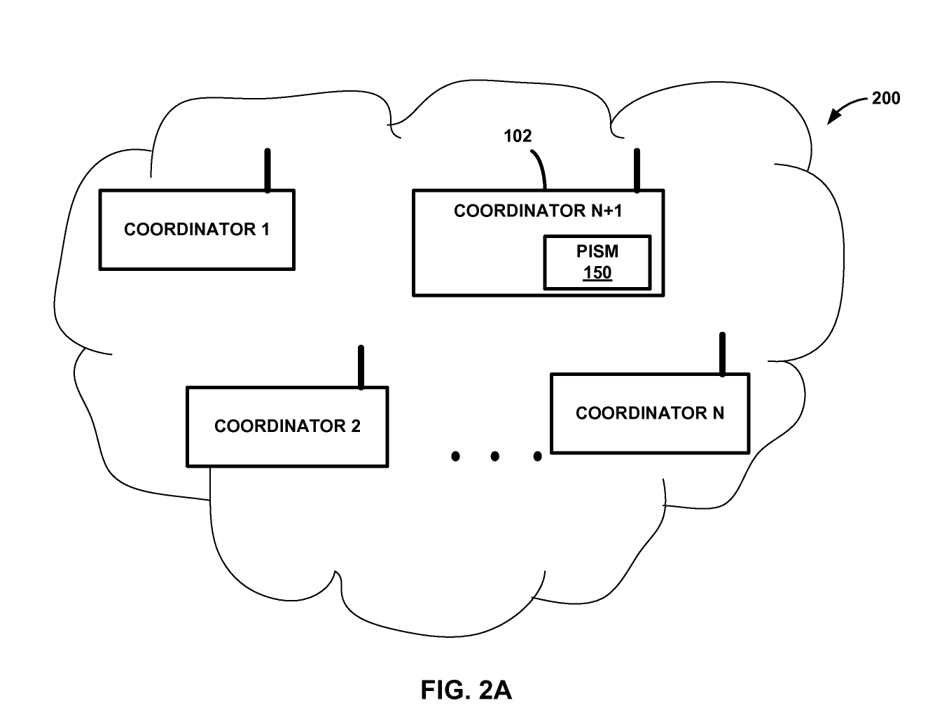

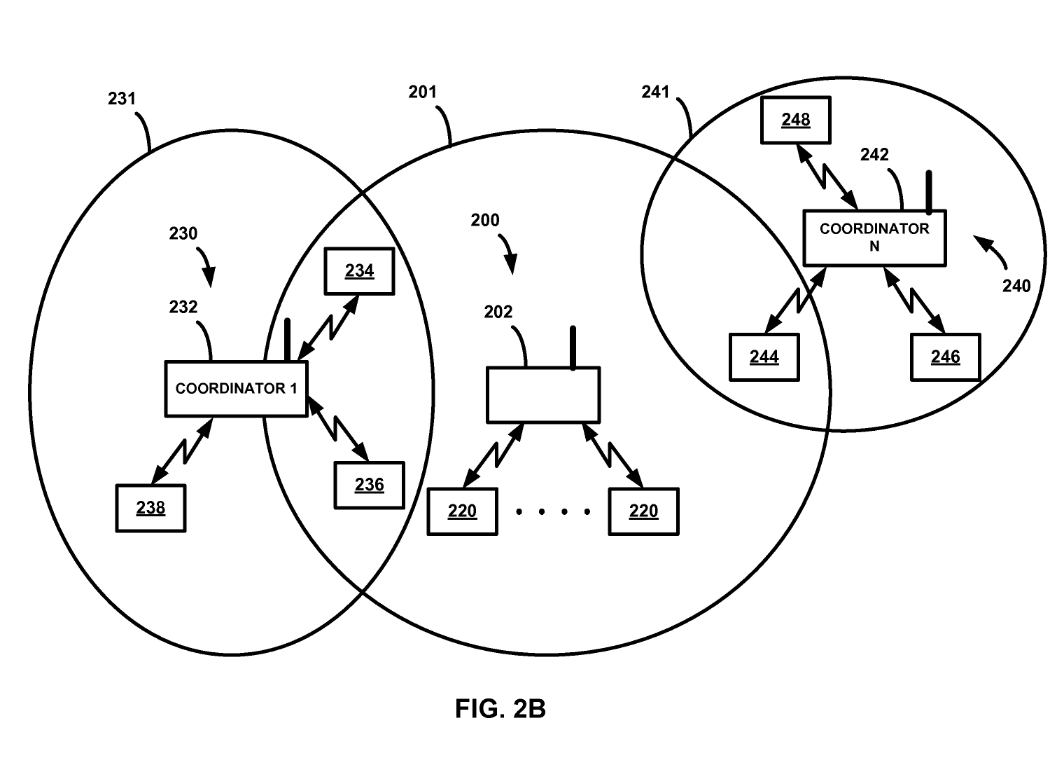

FIG. 2A is a block diagram illustrating an example set of wireless network coordinators 200 within a neighborhood or the scanning range of a wireless network coordinator 102. Each of coordinators 1−N may be associated with a wireless network (e.g., a ZigBee wireless network), and each coordinator may have an assigned PAN ID that identifies the associated wireless network. A user may wish to set up a new wireless network using coordinator 102.

In existing systems, when a new ZigBee wireless network is established, a coordinator N+1 for a new wireless network may not be able to select a truly unique PAN ID relative to PAN IDs associated with other networks nearby (e.g., the set of coordinators 200). When a new wireless network is established, the network's coordinator scans a range associated with the coordinator, to identify existing PAN IDs in the neighborhood and to generate a PAN ID that is different from the existing ones. However, coordinator 102 may not be able to capture all the existing PAN IDs associated with other network devices within the scanning range of coordinator 102. Additionally, coordinator 102 may have limited storage to store all the captured PAN IDs for comparison. As a result, coordinator 102 may generate a PAN ID that is associated with another wireless network within the scanning range of coordinator 102. This may be problematic in areas that are densely populated with wireless networks. Therefore, there is a need to ensure that a coordinator for a wireless network generates a PAN ID that is truly unique compared to other wireless networks and network devices associated with other wireless networks within a scanning range of the coordinator.

A user may utilize coordinator 102 to set up a new personal wireless network to control operations of end devices (e.g., end devices 120 of FIG. 1). Setting up the new network may include generating a PAN ID for the network, or an identifier for the network that the end devices that wish to join the network utilize to communicate with one another and with the coordinator. For example, coordinator 102 utilizes the PAN ID to establish connection with end devices 120 that utilize the same PAN ID.

In one implementation, coordinator 102 may scan for devices over a scanning range associated with coordinator 102. The devices may be existing coordinators 1−N and/or end devices associated with coordinators 1−N. The simplicity of ZigBee networks, for example, allows coordinator 102 to require little storage. Due to the storage limitations, coordinator 102 may be capable of acquiring information associated with a limited number of neighboring coordinators 1−N. For example, in existing implementations, coordinator 102 may be capable of acquiring PAN IDs of 5 neighboring networks or 5 networks within the scanning range of coordinator 102. Based on the 5 PAN IDs, coordinator 102 selects a PAN ID that is different from the 5 acquired PAN IDs, and as a result generates a PAN ID for the new network, where the generated PAN ID is unique relative to the 5 scanned PAN IDs.

However, in some situations, there may be more than 5 wireless networks within the scanning range of coordinator 102, i.e., N>=6. As a result, when coordinator 102 scans for neighboring networks or network devices, and acquires the first 5 PAN IDs associated with the networks or network devices it detects, coordinator 102 generates a unique PAN ID based on the 5 acquired PAN IDs, but may assign a PAN ID that is duplicative of an undetected network or network device within coordinator 102's range, e.g., a 6^{th} network PAN ID. Consequently, the number of unique PAN IDs in a certain range associated with a coordinator may be limited by the memory limitations of the coordinators of the networks, resulting in cross-talk or interference among devices associated with networks having identical PAN IDs.

Using the techniques of this disclosure, coordinator 102 may be used to set up a new wireless network, and generate a PAN ID for the new wireless network, where the PAN ID is unique compared to the PAN IDs associated with devices detected within the scanning range of coordinator 102, e.g., coordinators 1−N. During set up, coordinator 102 may utilize PAN ID selector module 150 to generate a random PAN ID, using a pseudorandom number generator (PRNG), for example. Coordinator 102 may scan within a scanning range corresponding to its transceiver to detect any other wireless networks by scanning for other coordinators and network devices such as, for example, coordinators 1−N. For each detected wireless network or network device, coordinator 102 compares the PAN ID with the generated PAN ID. If coordinator 102 determines that none of the wireless networks or network devices within its scanning range has the same PAN ID as the generated PAN ID, coordinator 102 assigns the generated PAN ID as the identifier for the wireless network associated with coordinator 102. Otherwise, if another wireless network or network devices within the range of coordinator 102 has the same PAN ID as the generated PAN ID, coordinator 102 generates another PAN ID and compares it to the PAN IDs associated with networks and devices within the range of coordinator 102, until a generated PAN ID is determined to be unique compared to PAN IDs associated with neighboring networks and network devices. In one example, if coordinator 102 does not detect any other networks or network devices within its scanning range, it assigns the generated PAN ID as the identified for the wireless network associated with coordinator 102.

FIG. 2B is a block diagram illustrating an example of a wireless network 200 relative to neighboring wireless networks 230 and 240. Each of wireless networks 200, 230, and 240 may comprise a coordinator device (e.g., coordinators 202, 232, and 242, respectively), and end devices in communication with the respective coordinators. While this example illustrates three wireless networks, it should be understood that these are merely illustrative for simplicity, and more or fewer wireless networks may exist within a close range of one another, and overlap as shown in FIG. 2B.

In the example of FIG. 2B, networks 230 and 240 may be already set up and functioning, where each may have an associated identifier, e.g., a PAN ID. Each of the devices of wireless networks 230 and 240 may utilize the corresponding PAN ID to communicate with other devices within the same network. For example, coordinator 232, and end devices 234, 236, and 238 of network 230 may utilize the same PAN ID to communicate with one another. Similarly, coordinator 242, and end devices 244, 246, and 248 of network 240 may utilize the same PAN ID to communicate with one another, where the PAN ID associated with network 240 is different from the PAN ID associated with network 230.

In one example, a user may utilize coordinator 202 to set up a new personal wireless network to control operations of end device 220. Coordinator 202 may be similar to coordinator 102 of FIGS. 1 and 2A. Coordinator 202 may scan for devices over a scanning range associated with coordinator 202. In one example, coordinator 202 may utilize passive scanning to determine whether other network devices are within its scanning range and the PAN IDs associated with such network devices. In passive scanning, coordinator 202 may intercept wireless messages or communications being transmitted within the scanning range of coordinator 202. Wireless messages typically include the PAN ID of the network within which they are being transmitted, and coordinator 202 may determine the PAN ID by examining the wireless message, e.g., looking at a header of the wireless message.

In another example, coordinator 202 may utilize active scanning to determine PAN IDs associated with network devices within the scanning range of coordinator 202. In active scanning, coordinator 202 may transmit broadcast transmissions with requests to network devices within the scanning range of coordinator 202. In one example, the request may be a request for the PAN ID associated with the network devices. In another example, the request may include the generated PAN ID and a confirmation as to whether the generated PAN ID is already being used by any network devices within the scanning range of coordinator 202.

In the example of FIG. 2B, the scanning range of coordinator 202 may be illustrated by circle 201. In this example, end devices 234 and 236 and coordinator 232 of wireless network 230 and end device of wireless network 240 may be within the scanning range 201 of coordinator 202. As coordinator 202 scans its range 201 for devices associated with other wireless networks, and determines the PAN IDs associated with any devices it finds within its range 201.

Using the techniques of this disclosure, coordinator 202 may utilize a PAN ID selector module (e.g., PISM 150 of FIGS. 1 and 2A) to generate a PAN ID, and compare the generated PAN ID to PAN IDs associated with network devices within range 201, e.g., end device 234, 236, and 244, and coordinator 232. If coordinator 202 determines that one of the network devices within its scanning range 201 has the same PAN ID as the generated PAN ID, coordinator 202 generates another PAN ID and compares it to the PAN IDs associated with devices within scanning range 201.

If coordinator 202 determines that none of the network devices within its scanning range 201 has the same PAN ID as the generated PAN ID, coordinator 202 assigns the generated PAN ID as the identifier for wireless network 200 associated with coordinator 202. Coordinator 202 may then send the generated PAN ID to end devices 220 that wish to join network 200. End devices 220 may utilize the PAN ID in communicating with coordinator 202 and coordinator 202 may utilize the PAN ID in communicating with end devices 220. For example, any messages sent from any of the devices in network 200 may identify the associated network using the PAN ID of the network. When a device, e.g., end device 220, receives a network message, the device determines the PAN ID from a PAN ID field in the message header, for example. If the PAN ID in the message matches the PAN ID of the network with which the device is associated, the device interprets the message accordingly. If the PAN ID in the message does not match the PAN ID of the network with which the device is associated, the device ignores the message.

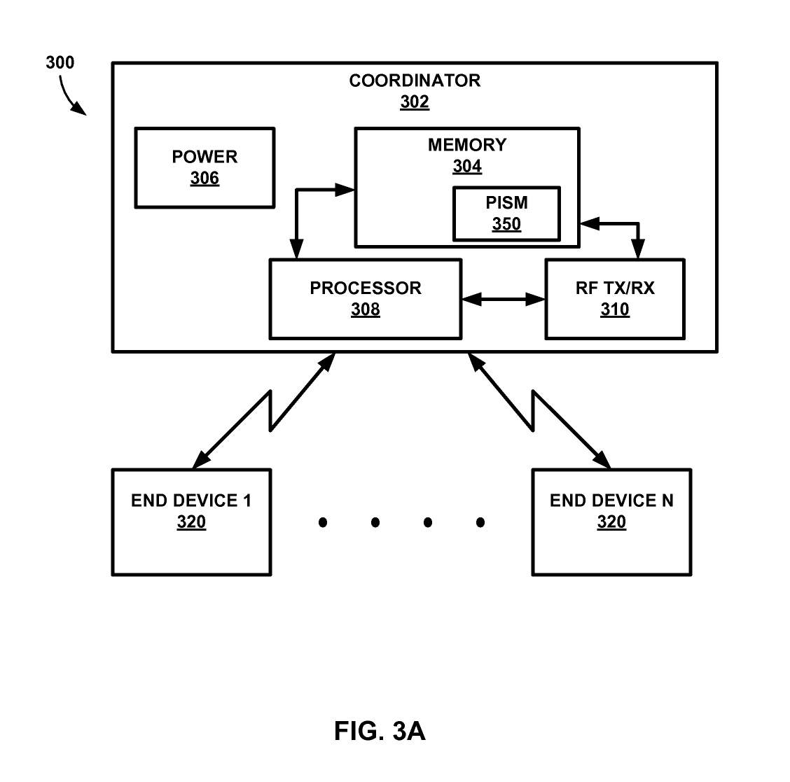

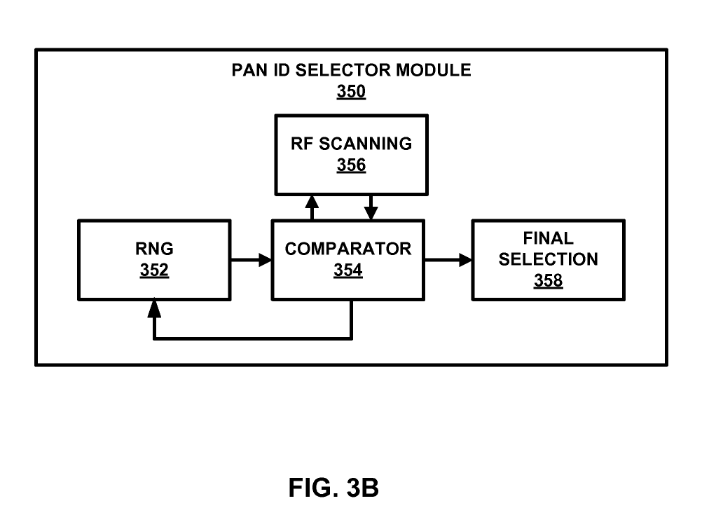

FIG. 3A is a block diagram illustrating an example wireless network 300 in accordance with techniques of this disclosure. Network 300 may include coordinator 302 (e.g., a ZigBee coordinator) and one or more end devices 320. Coordinator 302 may include memory 304, power source 306, processor 308, and radio frequency (RF) transceiver 310. Coordinator 302 may be similar to coordinators 102 and 202 of FIGS. 1, 2A, and 2B.

Memory 304 may include one or more computer-readable storage media. Memory 304 may comprise one or more storage devices, capable or long-term and short-term storage of information. Short-term storage of memory 304 may also be described as a volatile memory. Examples of volatile memories include random access memories (RAM), dynamic random access memories (DRAM), static random access memories (SRAM), and other forms of volatile memories known in the art. Long-term storage of memory 304 may also be described as non-volatile memory. Examples of such non-volatile storage elements may include magnetic hard discs, optical discs, floppy discs, flash memories, or forms of electrically programmable memories (EPROM) or electrically erasable and programmable (EEPROM) memories.

In one example, memory 304 may be used to store program instructions for execution by processor 308 such as, for example, PAN ID selector module 350. Memory 304 may be also used by software or applications running on coordinator 302 (e.g., PRNG algorithms, scanning functionality, communication protocols, or the like) to temporarily store information during program execution.

Processor 308 may be operable to execute one or more algorithms include, for example, a PRNG algorithm that generates a pseudorandom number using a seed and selecting a PAN ID. Processor 308 may also process data transmitted and received via transceiver 310. Additionally, processor 308 may make determinations regarding a PAN ID assigned to the wireless network associated with coordinator 302, according to the techniques described in this disclosure.

A user may utilize coordinator 302 to set up a new personal wireless network to control operations of end devices 320. Setting up the new PAN may include generating a PAN ID and assigning it to the network, or an identifier for the network that all the devices in the network utilize to communicate with one another. For example, coordinator 302 utilizes the PAN ID to communicate with end devices 320. As discussed above, the network established by coordinator 302 may have within its scanning range other coordinators and network devices associated with other wireless networks. Therefore, it may be beneficial to ensure that a PAN ID associated with a new wireless network established by coordinator 302 is unique relative to PAN IDs of wireless networks and devices within the scanning range of coordinator 302. In one example, the scanning range of coordinator 302 may be a distance, e.g., 50 feet or 100 feet, defining a range associated with transceiver 310, such that transceiver 310 may detect wireless signals transmitted by other devices within that range.

According to techniques of this disclosure, coordinator 302 may be configured to generate a unique PAN ID based on PAN IDs associated with neighboring wireless networks. Coordinator 302 may utilize PAN ID selector module 350 to select and assign a PAN ID for an associated wireless network. PAN ID selector module 350 may include a random number generator, a comparator, an RF scanning module, and final selection module. PAN ID selector module 350 may be implemented in hardware, software, or a combination thereof. In one example, PAN ID selector module 350 may be an algorithm stored in memory 304 and executed by processor 308.

In one example, the random number generator may comprise a PRNG algorithm to generate a random PAN ID. The PAN ID may be, for example, a 16-bit identifier. A PRNG typically uses a seed, or an initial value, to produce a sequence of bits, often using linear feedback shift registers and/or logical operations (e.g., OR, XOR, or the like). The sequence of bits generated using a PRNG has a periodicity associated with it. However, the period of the sequence of bits is often long enough to ensure some randomness or pseudo randomness when a portion of the sequence of bits is selected. The PRNG algorithm may be implemented in software, hardware, or a combination of hardware and software.

In one example, coordinator 302 may utilize an external stimulus as a seed for the PRNG. The external stimulus may be, for example, a button press by the user that results in generating a seed based on a timestamp, for example. The RF scanning module may then utilize RF transceiver 310 to scan within its scanning range for other network devices and acquire the PAN IDs associated with network devices within that range (e.g., scanning range 201 of FIG. 2B).

PAN ID selector module 350 may utilize the comparator to compare PAN IDs of neighboring wireless networks, or devices within the scanning range of coordinator 302, to the generated PAN ID. If coordinator 302 does not find within its scanning range devices associated with the same PAN ID, then the generated PAN ID is unique relative to other wireless networks within the scanning range of coordinator 302. If coordinator 302 finds within its scanning range devices associated with the same PAN ID, coordinator 302 generates a new PAN ID and repeats the comparison with the PAN IDs associated with devices in the scanning range of coordinator 302, until a unique PAN ID is generated.

In one example, coordinator 302 may generate a new PAN ID using the PRNG with another stimulus as a seed. In another example, coordinator 302 may increment the previously-generated PAN ID and use it as a new random PAN ID. In another example, coordinator 302 may increment the previous seed and use it as a seed to generate a new random sequence of bits, and so forth. Coordinator 302 may then scan within its scanning range and compare the newly-generated PAN ID with PAN IDs associated with neighboring network devices to determine whether the newly-generated PAN ID is unique. Coordinator 302 may repeat the generating and comparing, until a generated PAN ID is determined to be unique.

Once a unique PAN ID is generated, coordinator 302 may assign the unique PAN ID as the identifier of the associated wireless network. All end devices 320 that the user wishes to add to the wireless network of coordinator 302 may be set up with the unique PAN ID to establish communication with coordinator 302. When coordinator 302 and end devices 320 communicate, the likelihood of interference and cross-talk with other neighboring wireless network is greatly reduced.

In one example, coordinator 302 may utilize the same technique of using a PRNG to generate a security key to ensure secure communication between end devices 320 and coordinator 302. In one example, the security key may be a 128-bit key, and may be generated using the PRNG based on a seed derived from an external stimulus. In one example, coordinator 302 may utilize the PRNG to generate a unique PAN ID as discussed above, where the PRNG generates a 16-bit random number that is used as the PAN ID.

In another example, as noted above, coordinator 302 may generate a 128-bit random number, for example, and utilize the 128-bit number as a security key. Coordinator 302 may then utilize the 128-bit security key to select a PAN ID, where the PAN ID may comprise 16 bits, for example. The PAN ID may be, for example, the first 16 bits of the 128-bit security key.

In one example, the seed for the PRNG may be a button push on coordinator 302. In this example, the time difference between power up time and the time a user presses the button, down to the millisecond or microsecond, may be used as the seed to the PRNG. In one example, the seed may be utilized to generate a 16-bit number using the PRNG. The 16-bit number may be used as the generated PAN ID. In another example, the seed may be utilized to generate a 128-bit number using the PRND. The 128-bit number may be used as a security key for secure communication within the network associated with coordinator 302. In this example, a 16-bit subset of the generated 128-bit number may be used as the generated PAN ID.

If, as noted above, the selected PAN ID is not unique (e.g., because an identical PAN ID is associated with devices within range of coordinator 302), a different 16-bit PAN ID may be selected from the 128-bit security key. In one example, a PAN ID may be selected by using the first 16 bits of the 128-bit security key, and if the selected PAN ID is not unique, the next 16 bits of the 128-bit security key may be selected as a PAN ID, and so forth, until a unique PAN ID is selected.

FIG. 3B is a block diagram illustrating an example PAN ID selector module 350 in accordance with technique of this disclosure. PAN ID selector module 350 may be similar to PAN ID selector module 150 of FIGS. 1 and 2A. PAN ID selector module 350 may be implemented using software, hardware, or a combination thereof in coordinator 302 (FIG. 3A). PAN ID selector module 350 may comprise random number generator 352, comparator 354, RF scanning module 356, and final selection module 358.

In one example, random number generator 352 may comprise a PRNG, and may utilize a seed to generate a random number as discussed above. A PRNG typically uses a seed, or an initial value, to produce a sequence of bits, often using linear feedback shift registers and/or logical operations. The sequence of bits generated using a PRNG has a periodicity associated with it, and therefore, the sequence is not truly random. However, the period of the sequence of bit is long enough that it approximates the properties of random numbers. Sequences that are closer to truly random may be generated using hardware random number generators, however, using a PRNG may be more efficient and easier and faster to implement and requires fewer hardware components. Typically, the period associated with a PRNG is linked to the number of bits of the PRNG's internal state. Therefore, a larger number of bits in a PRNG may provide a more truly random 16-bit number, for example.

In one example, the seed for the PRNG may be obtained in response to an event or an external stimulus, e.g., the user pressing a button. Random number generator 352 may generate a random number to be used as a PAN ID for the wireless network associated with coordinator 302. Random number generator 352 may send the generated PAN ID to comparator 354.

In one example, comparator 354 may send a request to RF scanning module 356 to scan for other devices within a range associated with coordinator 302 and determine the PAN IDs for any devices within the range. RF scanning module 356 may utilize RF transceiver 310 to determine PAN IDs associated with other network devices. RF scanning module 356 may send each determine PAN ID to comparator 354, which compares each of the determined PAN IDs to the generated PAN ID received from random number generator 352. If any of the determined PAN IDs matches the generated PAN ID, comparator 354 sends a signal to random number generator 352 to generate another random PAN ID, which random number generator 352 then sends to comparator 354.

In one example, RF scanning module 356 may send a signal to comparator that no more devices with other PAN IDs are found within the range. If comparator 354 does not find a match between the generated PAN ID and any of the determined PAN IDs, comparator 254 sends the generated PAN ID to final selection module 358, thus indicating that a unique PAN ID has been found relative to the PAN IDs associated with other wireless networks and devices in the range of coordinator 302. Final selection module 358 then utilizes the generated PAN ID as the PAN ID of the wireless network associated with coordinator 302, which sends the PAN ID to any end devices that wish to join the associated wireless network. Additionally, any messages communicated among the devices of the wireless network associated with coordinator 302 may utilize the generated PAN ID in the communicated messages.

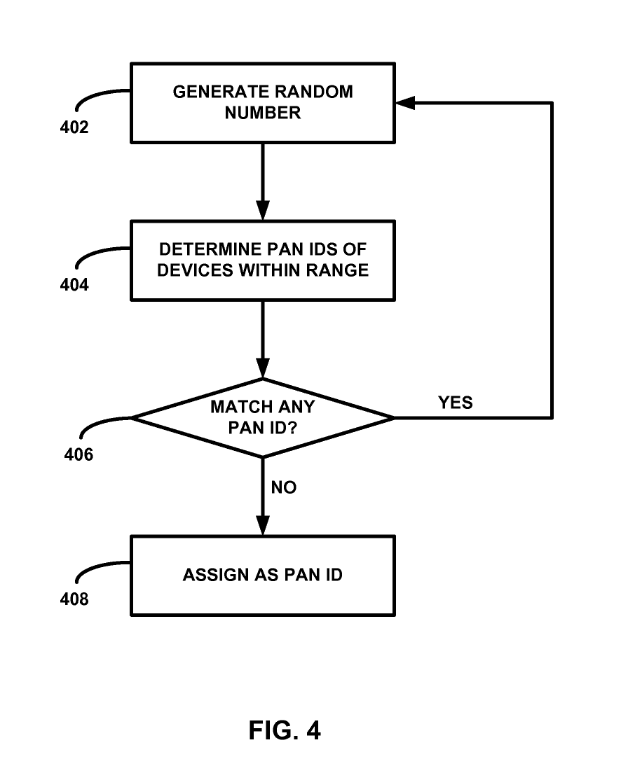

FIG. 4 is a flow chart of an example method for assigning a unique network identifier to a wireless network. The illustrated example method may be performed by coordinators 102, 202, and/or 302 (FIGS. 1-3A). In some examples, a computer-readable storage medium (e.g., memory 304 of FIG. 3A) may store instructions or modules (e.g., PAN ID selector module 150 or 350) that, when executed, cause one or more processors (e.g., processor 308) to perform one or more of the acts illustrated in the methods described herein.

The method of FIG. 4 includes PAN ID selector module 350 generating a random number (402) using a random number generation algorithm (e.g., RNG 352). As discussed above, the random number may be generated using a PRNG. PAN ID selector module 350 may obtain a seed in response to a stimulus (e.g., pressing a button or a timestamp) and use the obtained seed with the PRNG. In one example, the random number generation algorithm may be designed to generate a number of bits equivalent to the desired number of bits. For example, if PAN ID selector module 350 is designed to assign a 16-bit PAN ID to an associated wireless network, the random number generation algorithm may generate 16-bit random numbers.

In another example, the random number generation algorithm may generate a random number that is longer than the desired length, and a portion of the random number may be selected according to the desired number of bits. For example, the random number generation algorithm may generate a 128-bit random number, which coordinator 302 may utilize for other applications (e.g., as a security key for secure communication among devices of the associated wireless network). PAN ID selector module 350 may select a 16-bit portion of the generated 128-bit number to assign as a PAN ID.

PAN ID selector module 350 may then utilize RF scanning module 356 to scan within the scanning range of coordinator 302 (e.g., the range of the coordinator's transceiver) for devices associated with other networks and determine the PAN IDs associated with any such detected devices (404). The detected PAN IDs may be associated with devices belonging to other wireless networks, where the devices may be within a neighborhood of coordinator 302, or within a certain range where devices from the wireless networks may be able to interfere and cross-talk with each other, if each wireless network does not have its own unique PAN ID. For each detected PAN ID associated with other network devices that PAN ID selector module 350 scans, a comparison is made with the generated PAN ID to see if the detected PAN ID and the generated one match (406). PAN ID selector module 350 may repeat this for all detected PAN IDs associated with as many devices as there are within the range of coordinator 302. If none of the detected PAN IDs match the generated PAN ID, PAN ID selector module 350 assigns the generated PAN ID as the PAN ID for the associated wireless network (408).

If any of the detected PAN IDs matches the generated PAN ID, PAN ID selector module may generate another random number (402) to generate another PAN ID. In one example, PAN ID selector module 350 may generate a new random number using a new seed. In another example, PAN ID selector module 350 may increment the previously-generated random number. In the example where the PAN ID is selected as a portion of a generated random number that is longer than the required number of bits for a PAN ID, PAN ID selector module 350 may select another portion of the longer random number as a PAN ID. PAN ID selector module 350 may then determine PAN IDs associated with devices within its range (404) and compare to the new generated random PAN ID to see if there is a match (406), until a unique PAN ID is generated and coordinator 302 assigns it as the PAN ID for the associated wireless network (408). In one example, where coordinator 302 may not detect any other networks or network devices within its scanning range, coordinator 302 may assign the generated PAN ID as the PAN ID for the associated wireless network.

In one example, any end devices 320 interested in joining the wireless network may communicate with coordinator 302 indicating desire to join the network. Coordinator 302 may send the generated PAN ID to the end devices. When end devices 320 receive the PAN ID, all communication between coordinator 302 and end device 320 may include the generated PAN ID to identify the associated network. In this manner, if a device receives a message that has a PAN ID different from its own, the device ignores the message. If a device receives a message with a PAN ID associated with the network that the device belongs to, then the device may determine based on other information in the message, whether the message is intended for it or for another device in the network.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, a computer-readable storage medium may comprise a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various embodiments of the invention have been described. These and other embodiments are within the scope of the following claims.

1. A method comprising:
generating, by a random number generator in a network device, a random network identifier;
detecting identifiers associated with other network devices, wherein the other network devices are located within a scanning range associated with the network device;
comparing the identifiers associated with the other network devices with the generated random network identifier; and
assigning the generated random network identifier as an identifier of the network device when the generated random network identifier is unique relative to the identifiers associated with the other network devices.

2. The method of claim 1, further comprising, regenerating a random network identifier when the generated random network identifier is not unique.

3. The method of claim 2, wherein regenerating the random network identifier comprises incrementing the generated random network identifier.

4. The method of claim 1, wherein generating the random network identifier comprises:
generating, by the random number generator, a random security key, wherein the security key comprises a number of bits greater than a number of bits associated with the random network identifier; and
selecting a portion of generated security key, wherein the selected portion comprises a number of bits equal to the number of bits associated with the random network identifier.

5. The method of claim 4, further comprising regenerating a random network identifier when the generated random network identifier is not unique, wherein regenerating the random network identifier comprises selecting another portion of the generated security key.

6. The method of claim 1, further comprising obtaining a seed for the random number generator based on a user interaction with the network device.

7. The method of claim 6, further comprising regenerating a random network identifier when the generated random network identifier is not unique, wherein regenerating the random network identifier comprises obtaining a new seed for the random number generator.

8. A network device comprising:
a random number generator configured to generate a random network identifier;
a scanning module configured to detect identifiers associated with other network devices, wherein the other network devices are located within a scanning range associated with the network device;
a comparator configured to compare the identifiers associated with the other network devices with the generated random network identifier; and
a selection module for assigning the generated random network identifier as an identifier of the network device when the generated random network identifier is unique relative to the identifiers associated with the other network devices.

9. The network device of claim 8, wherein the random number generator is configured to regenerate a random network identifier, when the generated random network identifier is not unique.

10. The network device of claim 9, wherein regenerating the random network identifier comprises incrementing the generated random network identifier.

11. The network device of claim 8, wherein to generate the random network identifier, the random number generator is configured to:
generate a random security key, wherein the security key comprises a number of bits greater than a number of bits associated with the random network identifier; and
select a portion of generated security key, wherein the selected portion comprises a number of bits equal to the number of bits associated with the random network identifier.

12. The network device of claim 11, wherein the random number generator is configured to select another portion of the generated security key to regenerate a random network identifier when the generated random network identifier is not unique.

13. The network device of claim 8, wherein the random number generator is configured to obtain a seed for the random number generator based on a user interaction with the network device.

14. The network device of claim 13, wherein the random number generator is configured to obtain a new seed for the random number generator to regenerate a random network identifier when the generated random network identifier is not unique.

15. A computer-readable storage medium comprising instructions that, when executed, cause a processor of a network device to:
generate, by a random number generator, a random network identifier;
detect identifiers associated with other network devices, wherein the other network devices are located within a scanning range associated with the network device;
compare the identifiers associated with the other network devices with the generated random network identifier; and
assign the generated random network identifier as an identifier of the network device when the generated random network identifier is unique relative to the identifiers associated with the other network devices.

16. The computer-readable storage medium of claim 15, further comprising instructions that cause the processor to regenerate a random network identifier when the generated random network identifier is not unique.

17. The computer-readable storage medium of claim 16, wherein the instructions for regenerating the random network identifier comprise instructions that cause the processor to increment the generated random network identifier.

18. The computer-readable storage medium of claim 15, wherein the instructions for generating the random network identifier comprises instructions that cause the processor to:
generate a random security key, wherein the security key comprises a number of bits greater than a number of bits associated with the random network identifier; and
select a portion of generated security key, wherein the selected portion comprises a number of bits equal to the number of bits associated with the random network identifier.

19. The computer-readable storage medium of claim 18, further comprising instructions that cause the processor to regenerate a random network identifier when the generated random network identifier is not unique, wherein the instructions for regenerating the random network identifier comprise instructions that cause the processor to select another portion of the generated security key.

20. The computer-readable storage medium of claim 15, further comprising instructions that cause the processor to obtain a seed for the random number generator based on a user interaction with the network device.

21. The computer-readable storage medium of claim 20, further comprising instructions that cause the processor to regenerate a random network identifier when the generated random network identifier is not unique, wherein the instructions for regenerating the random network identifier comprise instructions that cause the processor to obtain a new seed for the random number generator.
